(19) United States
(12) Patent Application Publication
(10) Pub. No.: US 2015/0254448 A1
(43) Pub. Date: Sep. 10, 2015

(54) Verifying Human Use of Electronic Systems

(71) Applicant: Joshua Abraham Tabak, Seattle, WA (US)

(72) Inventor: Joshua Abraham Tabak, Seattle, WA (US)

(73) Assignee: GOOGLE INC., Mountain View, CA (US)

(21) Appl. No.: 13/459,389

(22) Filed: Apr. 30, 2012

(51) Int. Cl. H04L 9/32; G06F 21/00

(52) U.S. Cl. CPC G06F 21/36

(57) ABSTRACT

Described herein are techniques related to verifying human use of electronic systems. This Abstract is submitted with the understanding that it will not be used to interpret or limit the scope and meaning of the claims. A user-interaction module obtains a user's request to access and/or utilize an electronic system. A plain-text call generator in conjunction with a randomizer generates a random plain-text call. A modifier rule generator in conjunction with the randomizer generates a modifier rule. The user-interaction module transmits the random plain-text call and the random modifier rule to the user and obtains a response from the user. A comparison module compares the response by the user with an expected response and informs a verification module of the result. The verification module indicates a denial of access if the obtained response and expected response differ, and grants access if the obtained response and expected response match.

### BACKGROUND

Many people use the Internet and other electronic systems to open email accounts, to bank, to make electronic payments, to access and/or utilize databases, and to use classified advertising systems. Sometimes automated computer programs also attempt to access and/or utilize these electronic systems.

### SUMMARY

In general, one implementation of the subject matter disclosed herein is directed to a user-verification tool to control access by a user to an electronic system. The user-verification tool includes a user-interaction module that is configured to obtain an input from a user and to transmit outputs to the user. The user-verification tool also includes a plain-text call generator that is configured to generate a plain-text call and to facilitate display of the plain-text call to the user using the user-interaction module. The user-verification tool also includes a modifier rule generator that is configured to generate a plain-text rule modifier and to facilitate display of the plain-text rule modifier to the user using the user-interaction module. The plain-text rule modifier indicates that in a response to the plain-text call the user is to remove a select character from the plain-text call.

The user-verification tool also includes a randomizer that is configured to randomly select the plain-text call generated by the plain-text call generator and to randomly select the plain-text rule modifier generated by the modifier rule generator. The user-verification tool also includes a comparison module that is configured to obtain a plain-text response and to compare the obtained plain-text response to an expected plain-text response. The expected plain-text response is the plain-text call with the select character removed. The user-verification tool also includes a verification module that is configured to indicate that the user is to advance in the electronic system in response to a determination that the obtained plain-text response matches the expected plain-text response.

This Summary is submitted with the understanding that it will not be used to interpret or limit the scope or meaning of the claims. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an example user-verification tool according to one or more implementations described herein.

FIG. 2 through FIG. 6 illustrate example user interfaces according to implementations described herein.

FIG. 7 is a flowchart of a method for verifying a user of an electronic system according to one or more implementations described herein.

FIG. 8 is a high-level block diagram illustrating an example computer system suitable for implementing the technology described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

The technology described herein is a tool for verifying human use of electronic systems, such as email accounts, bank accounts, electronic payment systems, internal company databases, classified advertising systems, ticket-purchasing websites, sign-up forms, and/or registration forms, for example. The user-verification tool presents a plain-text “call” to a user. The user-verification tool also presents one or more “modifier rules” to the user. The user follows the modifier rule to enter a response to the plain-text “call.”

An example of a plain-text call includes requesting that the user to enter a sequence of numbers in a response box on the screen. An example modifier rule includes a request that the user omit a specific number from the plain-text sequence of numbers when entering the response to the plain-text call. Another example of a plain-text call includes requesting that the user to enter a sequence of letters in a response box on the screen. A corresponding example modifier rule includes a request that the user replace a specific letter in the plain-text call with another specific letter when entering the response to the plain-text call.

The plain-text calls and the modifier rules are selected randomly and/or arbitrarily, and presented to the user. Because the calls and modifier rules are presented in plain-text, visually impaired and non-visually impaired humans can use the tool effectively. Moreover, the random nature of the calls and modifier rules makes it difficult for an automated computer program to decipher what the proper responses should be. That is, although the calls and modifier rules are presented in plain text, the randomness of the plain-text calls and modifier rules increases the chance that if a correct response has been entered, it has been entered by a human. This is because implementing the modified rules involves logical reasoning based on semantic arguments that computer systems are not good at understanding. Additionally, inclusion of the modifier rule ensures that the correct response is never identical to the plain-text call. As used herein, an automated computer program is a computer script or program that functions to access and/or utilize electronic systems partially or wholly without human intervention. As used herein, the term “randomly” is intended to mean randomly and/or arbitrarily.

The user-verification tool includes a plain-text call generator, a modifier rule generator, a randomizer, a comparison module, a user-interaction module, and a verification module.

The plain-text call generator generates plain-text calls to be presented to the user via the user-interaction module. The plain-text call generator selects calls from a list of numbers, letters, words, and/or phrases, as well as icons, symbols, etc. In one example, the plain-text call generator generates “Enter the number 54378 in the box on the screen below” as the plain-text call. In another example, the plain-text call generator generates “Enter the BROWN in the box on the screen below” as the plain-text call.

The lists come from a corpus of documents, from a dictionary, and/or are randomly generated, for instance. That is, the list of numbers, letters, words, and/or phrases, as well as symbols, etc., that are part of the plain-text calls are either randomly selected from lists of items or are randomly generated on-demand. However, the plain-text calls themselves may be randomly generated or have a fixed framework. For example, in the fixed framework scenario a plain-text call is “Enter the number [CALL] in the box on the screen below,” while the letters, numbers, etc., in “[CALL]” are randomly generated. The fixed plain-text call is “Enter the number [CALL] in the box on the screen below,” and only the items in “[CALL]” change.

Alternatively, in the randomly generated framework, the plain-text call is “Please type [CALL] in the box below” in one instance and “In the box below, please type [CALL].” These are two different plain-text call frameworks that are randomly selected from a list of two or more choices.

The lists that are generated are subject to constraints such as allowable characters and length, for example. That is, in one or more implementations, the lists are randomly generated on-demand rather than being selected from a pre-existing list of randomly-generated items.

The plain-text call also may include instructions for the user to sense and/or emit a haptic emission that is a series of short and long vibrations, for example.

The modifier rule generator generates instructions that a user is to follow when entering a response to the plain-text call. In some example implementations, the modifier rule is a character ineligibility rule, which takes the form of “make certain that the number 4 is not included in your response.” In implementations in which the call is a haptic emission, the modifier rule is a character ineligibility rule that which takes the form of “make certain that the long taps are not included in your response.” The modifier rule may be a character replacement rule, which takes form of “make certain that the letter B is replaced with the letter C in your response.”

The randomizer is any suitable randomizing function capable of randomly selecting calls and/or modifier rules. In one or more implementations the randomizer is a random number generator, which is a physical hardware device that relies on radioisotope decay for selection of the plain-text calls and/or modifier rules. In one or more implementations, the randomizer is a pseudorandom number generator, which is a computerized random number generator based on an underlying algorithm. In one or more implementations, the randomizer is serial port or Universal Serial Bus (USB) pluggable module.

The comparison module is any suitable comparison function capable of comparing the actual response entered by a user to the expected response. The expected response is the plain-text call modified by what the modifier rule dictates.

If the entered response and the expected response match, the verification module allows the user to continue beyond the current stage in the electronic system. If the entered response and the expected response do not match, the plain-text call generator generates a new plain-text call and the modifier rule generator generates a new modifier rule. The new rule modifier includes additional instructions in the form of “please make sure to read all the instructions very carefully before entering your response.” The user-verification tool expects a new response from the user in light of the new plain-text call and the new modifier rule.

If the user persists in entering the identical plain-text response in response to the new plain-text calls and new modifier rules into the user-interaction module, it suggests that the user is not an intended user. In this case, the user-verification tool locks out that computer by locking out the Internet Protocol (IP) address for that device and/or by otherwise preventing the computer to access and/or utilize the electronic system.

The user-interaction module is any suitable interface that is capable of facilitating display of plain-text calls and modifier rules to a user, and receiving responses to the plain-text calls. In one or more implementations, the user-interaction module presents multiple plain-text calls and modifier rules, all of which must be responded to correctly before the user is allowed further access to the electronic system.

### Example User-Verification Tool

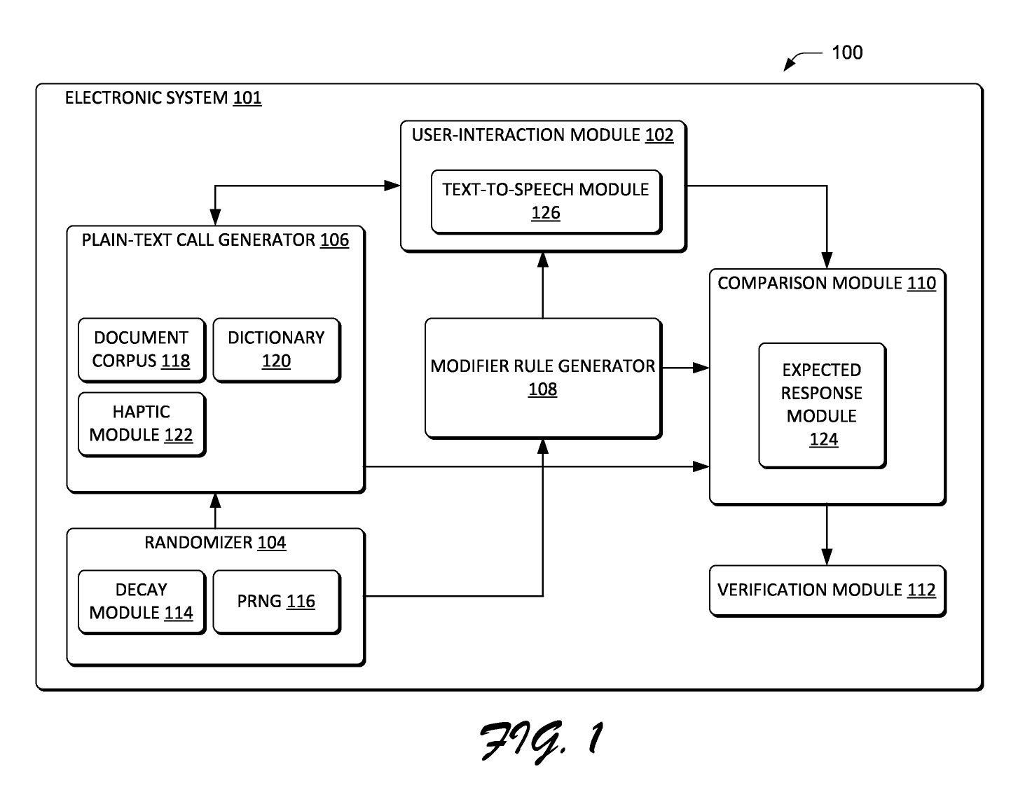

FIG. 1 illustrates an example user-verification tool 100 according to one or more implementations described herein that controls access to the electronic system 101, via a website, for example. The illustrated user-verification tool 100 includes user-verification tool includes a user-interaction module 102, a randomizer 104, a plain-text call generator 106, a modifier rule generator 108, a comparison module 110, and a verification module 112. The illustrated randomizer 104 includes a decay module 114 and a pseudorandom number generator (PRNG) 116. The illustrated plain-text call generator 106 includes a document corpus 118, a dictionary 120, and a haptic module 122. The illustrated comparison module 110 includes an expected response module 124. The illustrated user-interaction module 102 includes a text-to-speech module 126.

The illustrated electronic system 101 is any electronic system that a user wants to access and/or utilize online via a website. This includes email accounts, bank accounts, electronic payment systems, databases, classified advertising systems, and ticket purchasing websites. For example, the electronic system 101 is an email service registration system (e.g., Hotmail, Gmail, etc.), an online banking password system, an electronic payment system, databases (e.g., U.S. Patent and Trademark Office (USPTO) patent database), classified advertising systems (e.g., Craig's List), and ticket purchasing websites (e.g., Brown Paper Tickets, Ticketmaster®, etc.).

The electronic system 101 also is accessed without using a web site. For example, the electronic system 101 in one or more implementations is an internal database of a company, such as human resources documents, a payroll system, medical records, and the like. Similarly, the electronic system in one or more implementations is a personal computing device, such as a smartphone, a laptop computer, a desktop computer, a tablet computer, or the like. As such, in one or more implementations the user-verification tool 100 is used to access and/or utilize these electronic systems as well.

The illustrated user-interaction module 102 facilitates display of plain-text calls and modifier rules to a user. The illustrated user-interaction module 102 also facilitates receiving responses to the plain-text calls from users. In one or more implementations, the user-interaction module 102 receives a request from a user to access and/or utilize the electronic system 101.

In one or more implementations, the randomizer 104 assists the plain-text call generator 106 in generating a random plain-text call. For example, the randomizer 104 assists the plain-text call generator 106 in selecting a random plain-text call from the document corpus 118 and/or the dictionary 120. The randomizer 104 also assists the plain-text call generator 106 in generating a list of random plain-text calls for use.

For example, in one or more implementations, the randomizer 106 uses the radioisotope decay module 114 to randomize the plain-text call generated by the plain-text call generator 106.

In one or more other implementations, the randomizer 104 uses the PRNG 116 to randomize the plain-text call generated by the plain-text call generator 106. The PRNG 116 is a computerized random number generator based on an underlying algorithm. In one or more implementations, the randomizer 104 is serial port or Universal Serial Bus (USB) pluggable module.

In one or more implementations, the plain-text call generator 106 provides the random plain-text call to the modifier rule generator 108. The randomizer 104 assists the modifier rule generator 108 in generating a random modifier rule that corresponds to the random plain-text call. In one or more implementations, the randomizer 104 uses the radioisotope decay module 114 or the PRNG 116 to generate the random modifier rule that corresponds to the plain-text call generated by the plain-text call generator 106.

In one or more implementations, the plain-text call generator 106 provides the random plain-text call to the user-interaction module 102. Similarly, the modifier rule generator 108 provides the random modifier rule to the user-interaction module 102.

In the illustrated implementation, the comparison module 110 compares the input received from the user to an expected response. For example, the comparison module 110 compares the actual response entered by a user to the expected response. The illustrated expected response module 124 obtains the random plain-text call from the plain-text call generator 106 and the random modifier rule from the modifier rule generator 108. The expected response module 124 then determines an expected response, which is the plain-text call modified by what the modifier rule dictates.

If the entered response and the expected response match, the comparison module 110 instructs the verification module 112 to grant access. The verification module 112 then allows the user to continue beyond the current stage in the electronic system 101.

If the entered response and the expected response differ, the comparison module 110 instructs the verification module 112 to deny access. The verification module 112 also instructs the plain-text call generator 106 to generate a new random plain-text call and the modifier rule generator 108 to generate a new random modifier rule. The new random rule modifier includes additional instructions in the form of “please make sure to read all the instructions very carefully before entering your response.” The user-verification tool 100 expects a new response from the user in light of the new random plain-text call and the new random modifier rule.

The illustrated haptic module 122 in one or more implementations includes a touch-sensitive screen that emits vibrations, for example, and processes users' tactile feedback. In one or more implementations, the illustrated haptic module 122 includes a gyroscope that enables gesture recognition.

In one or more implementations, the text-to-speech module 126 includes any suitable voice synthesizer that converts language text into speech. The text-to-speech module 126 enables people with reading disabilities and/or visual impairments to utilize the user-verification tool.

In one or more implementations, the text-to-speech module 126 is a screen reader.

### Example User Displays

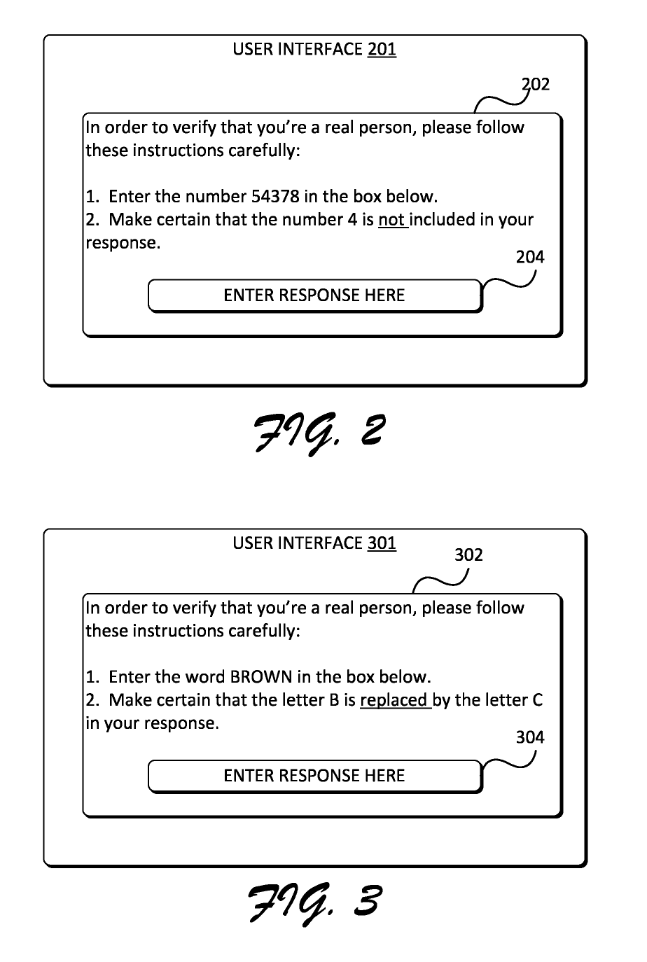

The user-interaction module 102 facilitates display of the random plain-text call and the corresponding random modifier rule on a user interface. FIG. 2 illustrates an example user interface (UI) 201 display for a user's screen when attempting to access and/or utilize the electronic system 101 via a website according to implementations described herein in which the plain-text call includes numbers. The UI 201 display includes a call/modifier box 202 that asks a user the following. “In order to verify that you're a real person, please follow these instructions carefully:.” The random plain-text call is “Enter the number 54378 in the box below.” The random modifier rule that corresponds to the random plain-text call is “Make certain that the number 4 is not included in your response.” The illustrated example also includes a response box 204 where the user is to enter a response. In keeping with the illustrated example, the expected response is 5378 that the user is to enter into the response box 204.

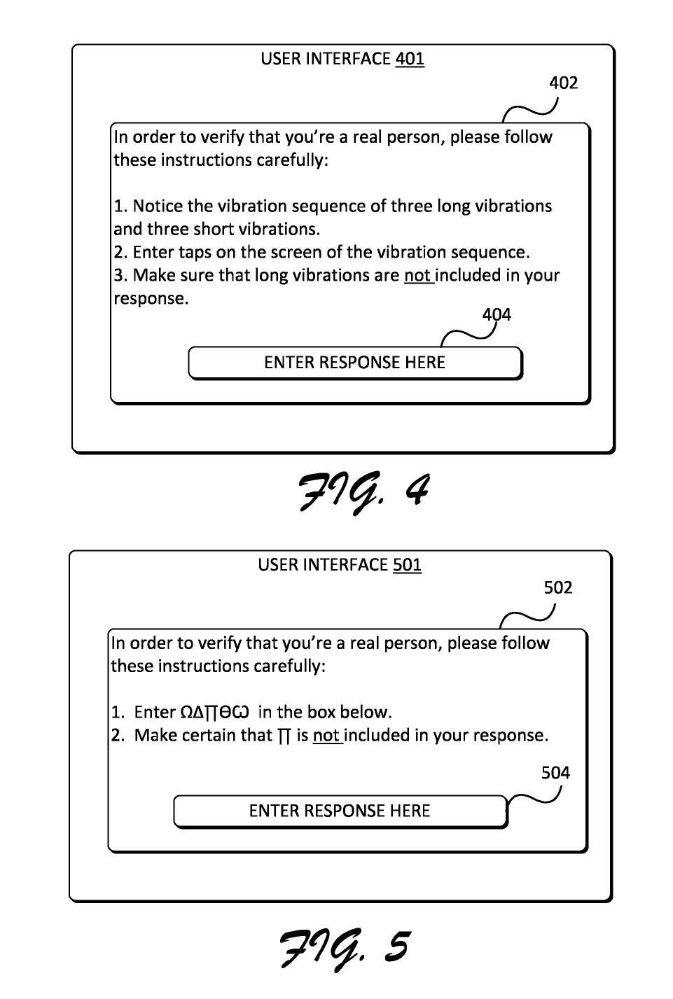

FIG. 3 illustrates an example user interface (UI) 301 display for a user's screen when attempting to access and/or utilize the electronic system 101 via a website according to alternative implementations described herein in which the plain-text call includes letters. The UI 301 includes a call/modifier box 302 that asks a user the following. “In order to verify that you're a real person, please follow these instructions carefully:.” The random plain-text call is “Enter the word BROWN in the box below.” The random modifier rule that corresponds to the random plain-text call is “Make certain that the letter B is replaced by the letter C in your response.” The illustrated example also includes a response box 304 where the user is to enter a response. In keeping with the illustrated example, the expected response is CROWN that the user is to enter into the response box 304.

FIG. 4 illustrates an example user interface (UI) 401 display for a user's screen when attempting to access and/or utilize the electronic system 101 via a website according to alternative implementations described herein in which the plain-text call includes haptic output patterns and touchscreen input patterns. The UI 401 includes a call/modifier box 402 that asks a user the following. “In order to verify that you're a real person, please follow these instructions carefully:.” The random plain-text call is “Notice the vibration sequence of three long vibrations and three short vibrations.” The random modifier rule that corresponds to the random plain-text call is “Enter taps on the screen of the vibration sequence” and “Make sure that long vibrations are not included in your response.” The illustrated example also includes a response box 404 where the user is to enter a response. In keeping with the illustrated example, the expected response is three short taps that the user is to enter into the response box 404.

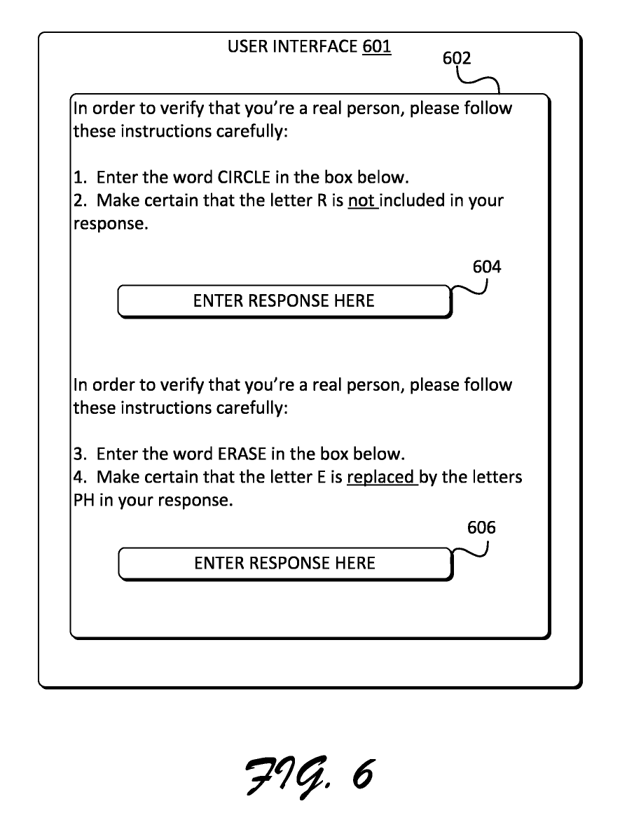

FIG. 5 illustrates an example user interface (UI) 501 display for a user's screen when attempting to access and/or utilize the electronic system 101 via a website according to alternative implementations described herein in which the plain-text call includes symbols. The UI 501 includes a call/modifier box 502 that asks a user the following. “In order to verify that you're a real person, please follow these instructions carefully:.” The random plain-text call is
Enter ΩΔΠθω in the box below.

The random modifier rule that corresponds to the random plain-text call is
Make certain that Π is not included in your response.

The illustrated example also includes a response box 504 where the user is to enter a response. In keeping with the illustrated example, the expected response is
ΩΔθω
   that the user is to enter into the response box 504.

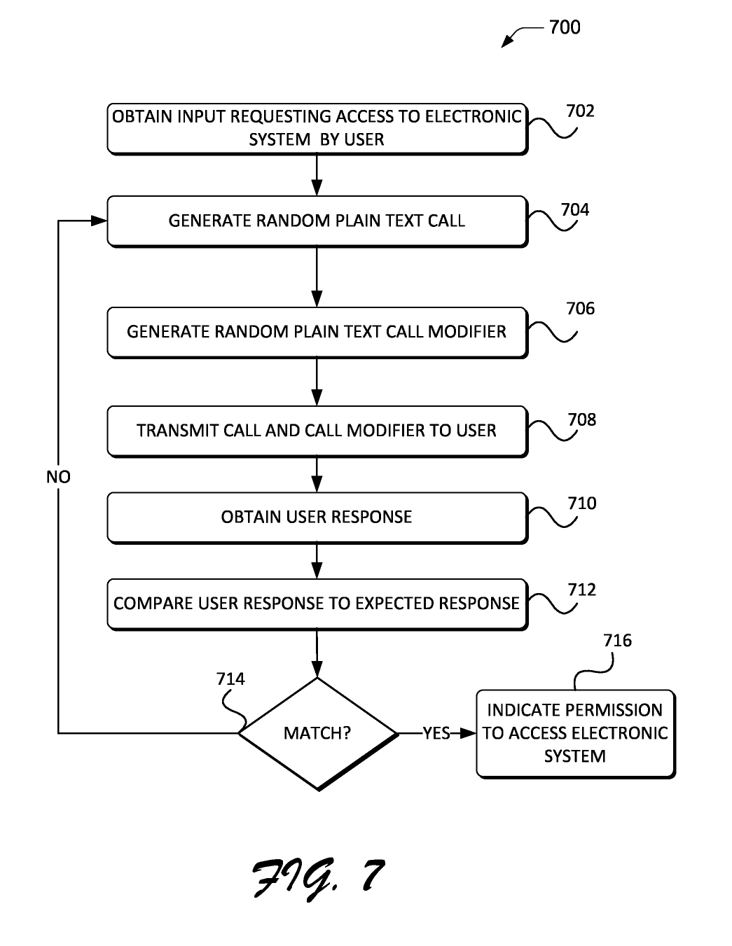

FIG. 6 illustrates an example user interface (UI) 601 display for a user's screen when attempting to access and/or utilize the electronic system 101 via a website according to alternative implementations described herein in which there are two plain-text calls and modifier rules. One plain-text call includes letters and one modifier rule includes a biometric input. The UI 601 includes a call/modifier box 602 that asks a user the following. “In order to verify that you're a real person, please follow these instructions carefully:.” The random plain-text call is “Enter the word CIRCLE in the box below.” The random modifier rule that corresponds to the random plain-text call is “Make certain that the letter R is not included in your response.” The illustrated example also includes a response box 604 where the user is to enter a response. In keeping with the illustrated example, the expected response is CICLE that the user is to enter into the response box 604.

The illustrated example, the call/modifier box 602 also asks a user the following. “In order to verify that you're a real person, please follow these instructions carefully:.” The random plain-text call is “Enter the word ERASE in the box below.” The random modifier rule that corresponds to the random plain-text call is “Make certain that the letter E is replaced by the letters PH in your response.” The illustrated example also includes a response box 606 where the user is to enter a response. In keeping with the illustrated example, the expected response is PHRASE that the user is to enter into the response box 606.

### Example Method of Verifying a User

FIG. 7 is a flowchart of a method 700 implemented by a user-verification tool, such as the user-verification tool 100 according to the technology described herein. For example, the user-interaction module 102 obtains a user request to access and/or utilize the electronic system 101. The plain-text call generator in conjunction with the randomizer 104 generates a random plain-text call. The modifier rule generator 108 in conjunction with the randomizer 104 generates a modifier rule. The user-interaction module 102 transmits the random plain-text call and the modifier rule to the user and obtains a response from the user. The comparison module 110 compares the response by the user with the expected response and informs the verification module 112 of the result. The verification module 112 denies access if there is no match and grants access if there is a match.

In a block 702, the user-verification tool 100 obtains an input requesting access to the electronic system 101 by a user. In one or more implementations, the user-interaction module 102 obtains an input requesting access to electronic system 101 101 by a user.

In a block 704, the user-verification tool 100 randomly generates a plain-text call in response to receiving the input requesting access to the electronic system 101 by the user. In one or more implementations, the plain-text call generator 106 in conjunction with the randomizer 104 randomly generate a plain-text call in response to receiving the input requesting access to the electronic system 101 by the user.

In a block 706, the user-verification tool 100 randomly generates a plain-text call modifier rule. In one or more implementations, the plain-text call generator 106 lets the modifier rule generator 108 know what the random plain-text call is. In response and in conjunction with the randomizer 104 the modifier rule generator 108 randomly generates a modifier rule that corresponds to the random plain-text call.

In a block 708, the user-verification tool 100 transmits the randomly generated plain-text call and randomly generated modifier rule to the user. In one or more implementations, the user-interaction module 102 transmits the randomly generated plain-text call and randomly generated modifier rule to the user.

In a block 710, the user-verification tool 100 obtains a response to the randomly generated plain-text call and randomly generated modifier rule from the user. In one or more implementations, the user-interaction module 102 obtains the response to the randomly generated plain-text call and randomly generated modifier rule from the user.

In a block 712, the user-verification tool 100 compares the response to the randomly generated plain-text call and randomly generated modifier rule obtained from the user to an expected response. In one or more implementations, the comparison module 110 compares the response to the randomly generated plain-text call and randomly generated modifier rule obtained from the user to the expected response as determined by the expected response module 124.

In a block 714, the user-verification tool 100 determines whether the user response matches (e.g., is the same as) the expected response. If the user response matches the expected response, then the control of the method 700 passes to a block 716 in which the user-verification tool 100 indicates that the user is permitted further access to the electronic system 101. In one or more implementations, the verification module 112 indicates that the user is permitted further access to the electronic system 101.

If the obtained response and the expected response do not match, control of the method 700 returns to block 704 and the method repeats blocks 704 through 714. In one or more implementations, the plain-text call generator 106 generates a new plain-text call and the modifier rule generator 108 generates a new modifier rule. The new rule modifier includes additional instructions in the form of “please make sure to read all the instructions very carefully before entering your response.” The user-verification tool 100 expects a new response from the user in light of the new plain-text call and the new modifier rule. Thus, the user-verification tool 100 makes allowances for mistakes.

If the user-interaction module 102 persists in obtaining the identical plain-text call in response to the new plain-text calls and new modifier rules into the user-interaction module 102, which suggests that the user is a non-person, the user-verification tool 100 concludes that an unintended user is trying to access and/or utilize the electronic system 101. In this case, the user-verification tool 100 locks out that computer by locking out the Internet Protocol (IP) address for that device.

It is understood that along with and/or in addition to the user-verification tool 100, other security features may be implemented to access and utilize the electronic system 101. The use of multiple security features, frequently termed “layering”, may be used to secure access to highly sensitive information. As one example, a user may be required to use the touch-screen security interface disclosed above with reference to the haptic module 122 before being required to negotiate a secondary security feature, such as one requiring the use of an authorization token.

The process 700 is illustrated as a collection of actions in a logical flow graph, which represents a sequence of operations that can be implemented in mechanics alone or a combination with hardware, software, and/or firmware. In the context of software/firmware, the actions represent instructions stored on one or more computer-readable storage media that, when executed by one or more processors, perform the recited operations. Note that the order in which the processes are described is not intended to be construed as a limitation, and any number of the described process blocks can be combined in any order to implement the processes or an alternate process. Additionally, individual actions may be deleted from the processes without departing from the spirit and scope of the subject matter described herein.

### Example Computing Environment

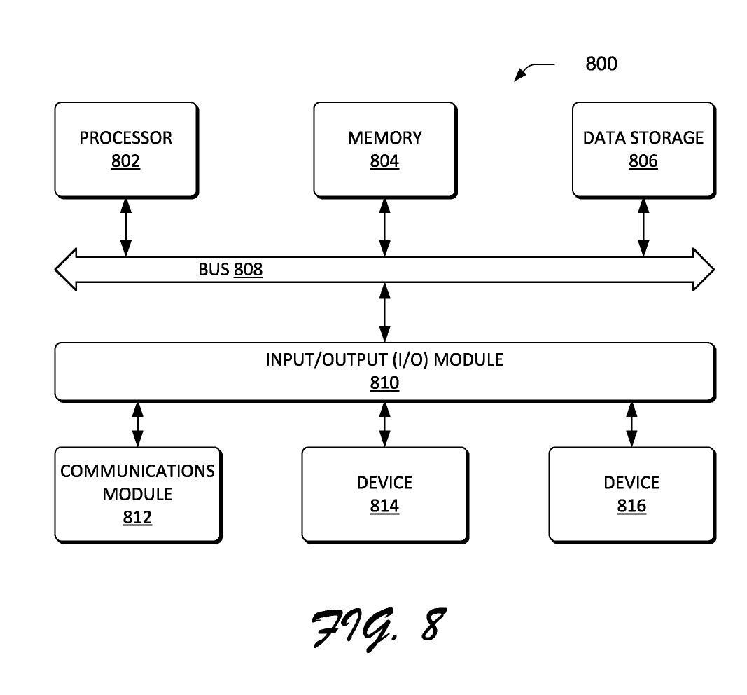

FIG. 8 is a high-level block diagram illustrating an example computer system 800 suitable for implementing the user-verification tool 100 of FIG. 1. In certain aspects, the computer system 800 may be implemented using hardware or a combination of software and hardware.

The illustrated computer system 800 includes a processor 802, a memory 804, and data storage 806 coupled to a bus 808 or other communication mechanism for communicating information. An input/output (I/O) module 810 is also coupled to the bus 808. A communications module 812, a device 814, and a device 816 are coupled to the I/O module 810.

The processor 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. The processor 802 may be used for processing information. The processor 802 can be supplemented by, or incorporated in, special purpose logic circuitry.

The memory 804 may be Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device used for storing information, a computer program, and/or instructions to be executed by the processor 802. They memory 804 may store code that creates an execution environment for one or more computer programs used to implement technology described herein.

A computer program as discussed herein does not necessarily correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Unless indicated otherwise by the context, a module refers to a component that is hardware, firmware, and/or a combination thereof with software (e.g., a computer program.) A computer program as discussed herein does not necessarily correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The instructions may be implemented in one or more computer program products, i.e., one or more modules of computer program instructions encoded on one or more computer readable media for execution by, or to control the operation of, the computer system 800, and according to any method well known to those of skill in the art. The term “computer-readable media” includes computer-storage media. For example, computer-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM))

The data storage 806 may be a magnetic disk or optical disk, for example. The data storage 806 may function to store information and instructions to be used by the processor 802 and other components in the computer system 800.

The bus 808 may be any suitable mechanism that allows information to be exchanged between components coupled to the bus 808. For example, the bus 808 may be transmission media such as coaxial cables, copper wire, and fiber optics, optical signals, and the like.

The I/O module 810 can be any input/output module. Example input/output modules 810 include data ports such as Universal Serial Bus (USB) ports.

The communications module 812 may include networking interface cards, such as Ethernet cards and modems.

The device 814 may be an input device. Example devices 814 include a keyboard, a pointing device, a mouse, or a trackball, by which a user can provide input to the computer system 800.

The device 816 may be an output device. Example devices 816 include displays such as cathode ray tubes (CRT) or liquid crystal display (LCD) monitors that display information, such as web pages, for example, to the user.

One or more implementations are described herein with reference to illustrations for particular applications. It should be understood that the implementations are not intended to be limiting. Those skilled in the art with access to the teachings provided herein will recognize additional modifications, applications, and implementations within the scope thereof and additional fields in which the technology would be of significant utility. In the above description of example implementations, for purposes of explanation, specific numbers, materials, configurations, and other details are set forth in order to better explain implementations as claimed. However, it will be apparent to one skilled in the art that the claims may be practiced using details different than the examples described herein. In other instances, well-known features are omitted or simplified to clarify the description of the example implementations.

For example, it will be appreciated that several of the above-disclosed and other features and functions, or alternatives thereof, may be combined into many other different systems or applications. Also, it will be appreciated that various presently unforeseen or unanticipated alternatives, modifications, variations or improvements therein may be subsequently made by those skilled in the art, which are also intended to be encompassed by the claims that follow.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

In the claims appended herein, the inventor invokes 35 U.S.C. §112, paragraph 6 only when the words “means for” or “steps for” are used in the claim. If such words are not used in a claim, then the inventor does not intend for the claim to be construed to cover the corresponding structure, material, or acts described herein (and equivalents thereof) in accordance with 35 U.S.C. §112, paragraph 6.

What is claimed is:

1-36. (canceled)

37. An apparatus comprising:
a memory to store a set of instructions;
a processor coupled to the memory, the processor to execute instructions to:
present, via a graphical user interface (GUI), a plain-text call, wherein the plain-text call is related, at least in part, to a haptic emission, the plain-text call specifying an expected response to the haptic emission;
cause the haptic emission that corresponds to the plain-text call to be emitted;
receive a response associated with the haptic emission;
compare the received response to the expected response; and
permit the user to advance in an electronic system when the received response corresponds to the expected response.

38. The apparatus of claim 37 wherein the processor is further to:
determine that the received response differs from the expected response; and
prevent the user from advancing in the electronic system in response to a determination that the received response differs from the expected response.

39. The apparatus of claim 37, wherein the expected response comprises a text-based response.

40. The apparatus of claim 37, wherein the expected response comprises a haptic response.

41. The apparatus of claim 40, wherein the expected response is different from the haptic emission.

42. The apparatus of claim 40, wherein the processor is further to ensure that the haptic emission and the expected haptic response are different.

43. The apparatus of claim 37, wherein the processor is further to:
receive a response to the haptic emission;
compare the response to the haptic emission to an expected response to the haptic emission;
determine that the received response to the haptic emission matches an expected response to the haptic emission; and
permit the user to advance in the electronic system in response to a determination that the response to the haptic emission matches the expected response to the haptic emission.

44. The apparatus of claim 43, wherein the haptic emission is a first number of vibrations, and wherein the expected response is a haptic response that comprises the first number of vibrations.

45. The apparatus of claim 43, wherein the processor is further to:
present, via the GUI, a plain-text rule modifier to specify that the expected response is to include a modification to the haptic emission.

46. The apparatus of claim 45, wherein the haptic emission is a first number of device-generated vibrations, and wherein the plain-text rule modifier specifies that the expected response is to include a second number of user-generated vibrations.

47. The apparatus of claim 37, wherein the processor is further to randomly generate the plain-text call using at least one of a radioisotope decay random number generator.

48. The apparatus of claim 37, wherein the processor is further to randomly generate the plain-text call using a pseudorandom number generator.

49. The apparatus of claim 37, wherein the processor is further to select the plain-text call from a corpus of documents.

50. The apparatus of claim 37, wherein the processor is further to select the plain-text call from a dictionary.

51. The apparatus of claim 37, wherein the processor is further to select the plain-text call and the haptic emission from a list of randomly generated plain-text calls and a list of randomly generated haptic emissions.

52. The apparatus of claim 37, wherein the processor is further to randomly generate the plain-text call based on an allowed number of characters in the plain-text call and an allowed length of the plain-text call.

53. The apparatus of claim 37, wherein the processor is further to prevent the user from advancing in the electronic system in response to a determination that at least two received responses differ from at least two expected responses.

54. The apparatus of claim 37, wherein presenting the plain-text call via the GUI includes requesting a haptic input from the user.

55. The apparatus of claim 37, wherein the processor is further to ensure that the plain-text call and the expected response are different.

56. A method comprising:
presenting, via a graphical user interface (GUI), a plain-text call, wherein the plain-text call is related, at least in part, to a haptic emission, the plain-text call specifying an expected response to the haptic emission;
causing the haptic emission that corresponds to the plain-text call to be emitted;
receiving a response associated with the haptic emission from the user;
comparing the received response to the expected response; and
permitting the user to advance in an electronic system when the received response corresponds to the expected response.

57. The method of claim 56, wherein the haptic emission is a first number of vibrations, and wherein the expected response is a haptic response that comprises the first number of vibrations.

58. The method of claim 56, wherein the haptic emission is a first number of vibrations, and wherein the expected response to the haptic emission is a haptic response that comprises a second number of vibrations.

59. The method of claim 56 further comprising presenting, via the GUI, a plain-text rule modifier to specify that the expected response is to include a modification to the haptic emission.

60. The method of claim 59, wherein the haptic emission is a first number of device-generated vibrations, and wherein the plain-text rule modifier specifies that the expected response is to include a second number of user-generated vibrations.

61. The method of claim 56, wherein the expected response comprises a haptic response.

62. The method of claim 56, wherein the plain-text call having multiple options, at least one of the options being related to the haptic emission.

63. The method of claim 62 further comprising randomly generating the plain-text call.

64. A mobile device comprising:
a memory to store a set of instructions;
a processor coupled to the memory, the processor to execute instructions to:
present, via a graphical user interface (GUI), a plain-text call, wherein the plain-text call having a plurality of options, at least of the plurality of options being related to a haptic emission, the plain-text call specifying an expected response to the haptic emission;
cause the haptic emission that relates to the plurality of options to be emitted;
receive a response associated with the haptic emission;
compare the received response to the expected response; and
permit the user to advance in an electronic system when the received response corresponds to the expected response.

65. The mobile device of claim 64, wherein the expected response comprises a haptic input.

66. The mobile device of claim 65, wherein the processor is further to:
present, via the GUI, a plain-text rule modifier to specify that the haptic input is to include a modification to the haptic emission.

67. The mobile device of claim 66, wherein the haptic emission is a first number of vibrations, and wherein the plain-text rule modifier specifies that the expected response is to include a second number of vibrations.

68. A non-transitory computer-readable medium to store processor-executable instructions that when executed cause one or more processors to perform operations comprising:
presenting, via a graphical user interface (GUI), a plain-text call, wherein the plain-text call is related, at least in part, to a haptic emission, the plain-text call specifying an expected response to the haptic emission;
causing the haptic emission that corresponds to the plain-text call to be emitted;
receiving a response associated with the haptic emission;
comparing the received response to the expected response; and
permitting the user to advance in an electronic system when the received response corresponds to the expected response.

69. The non-transitory computer-readable medium of claim 68, wherein the haptic emission is a first number of vibrations, and wherein the expected response is a haptic response that comprises the first number of vibrations.

70. The non-transitory computer-readable medium of claim 68, wherein the haptic emission is a first number of vibrations, and wherein the expected response to the haptic emission is a haptic response that comprises a second number of vibrations.

71. The non-transitory computer-readable medium of claim 68 further comprising presenting, via the GUI, a plain-text rule modifier to specify that the expected response is to include a modification to the haptic emission.

72. The non-transitory computer-readable medium of claim 71, wherein the haptic emission is a first number of device-generated vibrations, wherein the plain-text rule modifier specifies that the expected response is to include a second number of user-generated vibrations.
